(19) United States
(12) Patent Application Publication
(10) Pub. No.: US 2026/0051316 A1
(43) Pub. Date: Feb. 19, 2026

(54) SPATIALLY AWARE AUDIO-AUGMENTED CONVERSATIONAL AGENTS

(71) Applicant: NVIDIA Corporation, Santa Clara, CA (US)

(72) Inventors: Ante JUKIC, Culver City, CA (US); Jagadeesh BALAM, Campbell, CA (US)

(73) Assignee: NVIDIA Corporation, Santa Clara, CA (US)

(21) Appl. No.: 18/807,130

(22) Filed: Aug. 16, 2024

(51) Int. Cl. G10L 15/06; G10L 15/183; G10L 15/30; G10L 19/008; G10L 25/57

(52) U.S. Cl. CPC G10L 15/063; G10L 15/183; G10L 15/30; G10L 19/008; G10L 25/57; G10L 2015/0635

(57) ABSTRACT

In various examples, systems and methods are disclosed relating to spatially aware audio-augmented conversational agents. A system can generate an encoded representation of multichannel audio data corresponding to a machine-learning model. The system can generate a training dataset for the machine-learning model using the encoded representation. The training dataset can indicate spatial information for at least one audio source represented in the multichannel audio data. The system can use the training dataset to update one or more parameters of the machine-learning model to generate output corresponding to input spatial audio.

### BACKGROUND

Language models—such as large language models (LLMs)—can be used to process text data (e.g., in natural language) to implement conversational agents. Multi-modal language models include language models that are trained to additionally process other modes of information, such as audio data, image data, and/or other types of data. However, existing solutions generally are not designed to process multichannel (e.g., stereo or binaural) audio data, and can instead only process monophonic audio data (e.g., having a single audio channel).

### SUMMARY

Multi-modal language models that process audio data operate by first encoding input audio data into a numerical format using techniques such as tokenization, and subsequently processing the tokenized audio using machine-learning layers such as transformer layers. Conventional approaches for processing audio data with multi-modal models only operate using single channel audio data. Single channel audio data is represented as audio information from a single source and can only include audio intensity (e.g., volume) across time, without providing spatial (e.g., directional) characteristics of sound.

In contrast, multichannel audio data includes audio from multiple audio sources, enabling spatial information, such as the location and motion of sound sources, to be derived from changes in audio intensity between each audio channel. A common type of multichannel audio is stereo or binaural audio, which includes two channels of audio, however any number of channels may be implemented in multichannel audio. This variability in audio makes it challenging to encode multichannel audio for use with multi-modal language models.

Embodiments described herein implement multichannel audio with multi-modal language models by converting multichannel audio with an arbitrary number of audio sources to a device-agnostic audio format. The device-agnostic format may be, for example, B-format audio, which can include a fixed number of component channels that collectively represent a full-sphere sound field. As the number of component channels are fixed and separate from the number of audio sources/channels used to record the initial audio data, the device-agnostic format can be tokenized using a tokenizer trained for a multi-modal language model. The use of multichannel audio in training/updating multi-modal language models allows the models to learn the spatial characteristics of audio. As a result, conversational agents (e.g., chatbots, non-player characters (NPCs), digital humans, avatars, digital assistants, etc.) deployed using multi-modal language models that process audio in this way may perform more realistically as they are able to leverage spatial awareness from audio (and/or other sources, such as image, video, environmental simulation, etc.) when interacting with users.

At least one aspect relates to one or more processors. The one or more processors can include one or more circuits. The one or more circuits can generate an encoded representation of the multichannel audio data corresponding to a machine-learning model. The one or more circuits can generate a training dataset for the machine-learning model using the encoded representation. The training dataset can indicate spatial information for at least one audio source represented in the multichannel audio data. The one or more circuits can update, using the training dataset, one or more parameters of the machine-learning model to generate output corresponding to input spatial audio.

In some implementations, the machine-learning model comprises at least one of a large language model (LLM), a vision language model (VLM), or a multi-modal language model (MMLM). In some implementations, the spatial information comprises text data. In some implementations, the one or more circuits can update the one or more parameters of the machine-learning model to generate output text data relating to at least an audio source represented in the input spatial audio. In some implementations, the output text data identifies one or more of a distance to the audio source represented in the input spatial audio, a number of audio sources represented in the input spatial audio, or a transcription or diarization output of speech from a moving audio source represented in the input spatial audio.

In some implementations, the one or more circuits can generate the multichannel audio data by applying a spatial transform operation to a plurality of audio sources. In some implementations, the spatial transform operation generates the multichannel audio data as B-format audio. In some implementations, the one or more circuits can update the one or more parameters of the machine-learning model to generate output spatial audio according to the input spatial audio.

In some implementations, the one or more circuits can generate the training dataset to include an encoded representation of video data. In some implementations, the one or more circuits can update, using the training dataset, the one or more parameters of the machine-learning model to generate output spatial audio tracking at least one audio source depicted in the video data. In some implementations, the one or more circuits can update the one or more parameters of the machine-learning model to receive single channel audio data and the encoded representation of the video data to generate the output spatial audio.

At least one aspect relates to a system. The system can include one or more processors. The system can receive, from a client device, an input audio for a language model trained to process multichannel audio data. The system can generate, using the input and the language model, output data indicative of spatial information of at least one audio source represented in the input audio. The system can provide the output data indicative of the spatial information to the client device.

In some implementations, the system can generate an encoded representation of the multichannel audio data corresponding to a machine-learning model. In some implementations, the system can provide the encoded representation as input to the language model. In some implementations, the system can receive input text for the language model. In some implementations, the system can generate, using the language model, the output data indicate of the spatial information based on the input text and the input audio.

In some implementations, the system can receive input video for the language model. In some implementations, the system can generate, using the language model, the output data indicate of the spatial information based on the input video and the input audio. In some implementations, the output data comprises an encoded output of the language model. In some implementations, the system can generate output multichannel audio based on the encoded output of the language model. In some implementations, the output data comprises one or more of a number of sound sources represented in the input audio, an estimated distance of a sound source represented in the input audio, or an estimated location of a sound source represented in the input audio.

At least one aspect is related to a method. The method can include generating, using one or more processors, an encoded representation of the multichannel audio data corresponding to a machine-learning model. The method can include generating, using the one or more processors, a training dataset for the machine-learning model using the encoded representation. The training dataset can indicate spatial information for at least one audio source represented in the multichannel audio data. The method can include updating, using the one or more processors and the training dataset, the one or more parameters of the machine-learning model to generate output corresponding to input spatial audio.

In some implementations, the spatial information comprises text data. In some implementations, the method can include updating, using the one or more processors, the one or more parameters of the machine-learning model to generate output text data relating to at least an audio source represented in the input spatial audio. In some implementations, the output text data identifies one or more of a distance to the audio source represented in the input spatial audio, a number of audio sources represented in the input spatial audio, or a transcription of speech from a moving audio source represented in the input spatial audio.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system implemented using an edge device, a system implemented using a robot, a system for performing conversational AI operations, a system for performing generative AI operations using a language model, a system for performing generative AI operations using a large language model, a system for performing generative AI operations using a vision language model, a system for performing generative AI operations using a multi-model language model, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for spatially aware audio-augmented conversational agents are described in detail below with reference to the attached drawing figures, wherein:

FIG. 1 is a block diagram of an example system for implementing spatially aware audio-augmented conversational agents, in accordance with some embodiments of the present disclosure;

FIG. 2 depicts a dataflow diagram showing how spatially aware audio-augmented conversational agents can be used to process different types of data, in accordance with some embodiments of the present disclosure;

FIG. 3 is a flow diagram of an example of a method for training/updating spatially aware audio-augmented conversational agents, in accordance with some embodiments of the present disclosure;

FIG. 4A is a block diagram of an example generative language model system suitable for use in implementing at least some embodiments of the present disclosure;

FIG. 4B is a block diagram of an example generative language model that includes a transformer encoder-decoder suitable for use in implementing at least some embodiments of the present disclosure;

FIG. 4C is a block diagram of an example generative language model that includes a decoder-only transformer architecture suitable for use in implementing at least some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods for implementing spatially aware and audio-augmented conversational agents. Conversational agents can be implemented using machine-learning models such as large language models (LLMs), vision language models (VLMs), multi-modal language models (MMLMs), etc. Generative artificial intelligence models, such as LLMs/VLMs/MMLMs/etc., can receive and process information representing various media modalities, including audio, video, image, and text. Machine-learning models that are trained/updated to receive input data having different media modalities may be referred to as “multi-modal models,” or MMLMs.

Processing information for use in generative multi-modal models involves encoding said information into a numerical format using techniques such as tokenization. Generally, tokenization converts input data into a format that is compatible with the input layers of the machine-learning models. Some machine-learning models implement audio-based processing, in which streams of audio information are encoded and provided as input to the machine-learning model. These encoding processes process single-channel audio data into a numerical format for processing.

Single-channel audio data refers to audio that is recorded or encoded using only one audio channel. Single-channel audio data includes only mono audio data without any spatial encoding. Conventional audio-based machine-learning models, which only process single-channel audio data, cannot process spatial information from audio sources represented in input audio data. As such, various contextual information relevant for conversational agents cannot be implemented using conventional machine-learning models.

The systems and methods described herein implement techniques for processing multi-channel audio data, which encodes spatial information from an arbitrary number of audio sources. The techniques described herein can implement audio processing for any number of audio channels. To do so, a spatial transformation can be applied to multichannel microphone array signals to generate a device-agnostic audio format. One example of a device agnostic spatial audio format is an ambisonics representation. The spatial transformation may correspond to the multichannel microphone system that records the audio data.

Once encoded into the spatial audio format, a multichannel audio encoder encodes the spatial audio into a suitable format for the machine-learning model (e.g., via tokenization). Such machine-learning models may also include multi-modal models that receive input from combinations of audio, text, or other modalities such as images or video. For example, special tokens or inputs for an LLM/VLM/MMLM/etc. can designate portions of an input context sequence that correspond to audio data and portions that correspond to text data.

Machine-learning models trained/updated according to these techniques can process both the content and spatial context of input audio data. Unlike conventional approaches, the techniques described herein can implement machine-learning models trained/updated to identify, isolate, and process content of individual audio sources or directional audio. Spatial information can be used to track or estimate the position of speech, audio sources, or derive further insights from spatial audio that conventional machine-learning models cannot generate. The systems and methods described herein therefore improve upon approaches for audio processing by extending the functionality of conventional machine-learning models.

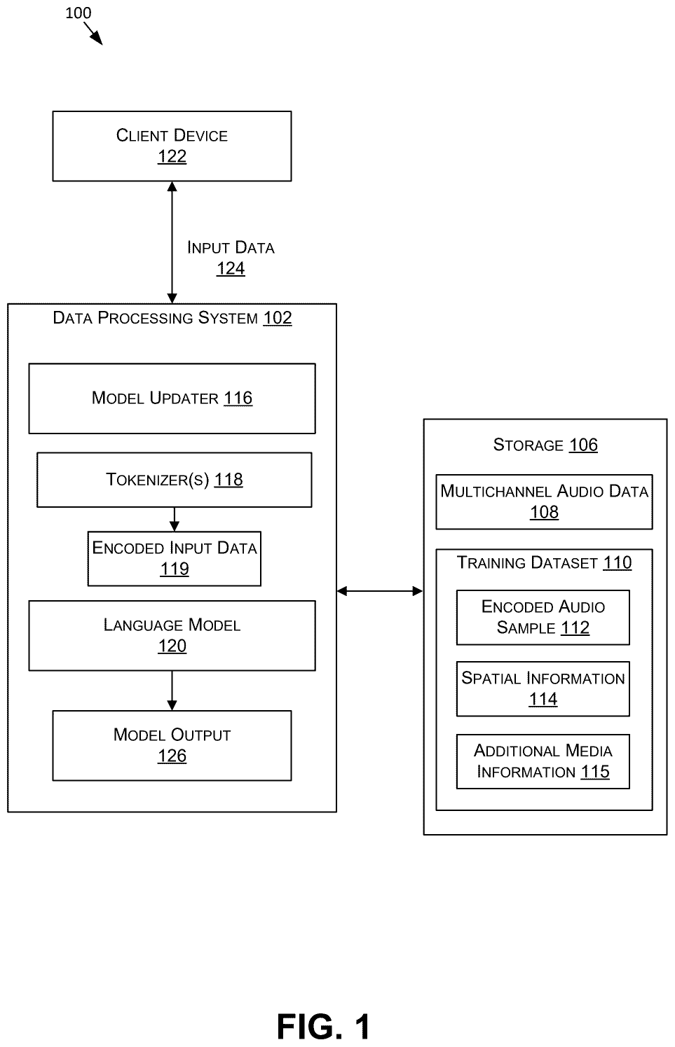

With reference to FIG. 1, FIG. 1 is an example computing environment including a system for implementing spatially aware audio-augmented conversational agents, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including a data processing system 102. The data processing system 102 can include one or more processors, circuits, memory, and/or computing devices/systems that can perform the various techniques described herein. The data processing system 102 can be implemented, for example, in a cloud computing environment and/or at the edge, which may maintain, update, and/or execute one or more language models 120 (e.g., LLMs/VLMs/MMLM/etc.). The data processing system 102 can implement the various techniques described herein to train/update a language model 120 to learn to extract, process, or interpret spatial characteristics of multichannel audio data. To do so, the data processing system 102 (or the components thereof) can access the storage 106 to generate and/or retrieve a training dataset 110, which can include encoded audio samples 112 (e.g., encoded multichannel audio data 108) and corresponding spatial information 114.

As shown, in this example, the data processing system 102 is in communication with the storage 106. The storage 106 may be an external server, distributed storage/computing environment (e.g., a cloud storage system), or any other type of storage device or system that is in communication with the data processing system 102. Although shown as external to the data processing system 102, it should be understood that the storage 106 may form a part of, or may otherwise be internal to, the data processing system 102. The storage 106 may be accessed when storing multichannel audio data 108 (e.g., provided by one or more client devices 122), generating a training dataset 110, or any other operations described herein.

As described herein, conventional multi-modal or audio-specific language models are not configured to process multichannel audio data 108 and are instead only configured to process single channel (e.g., monophonic audio) data and/or to process multichannel audio data using single channel processing techniques (which results in a loss of spatial reasoning or understanding). To address these issues, the data processing system 102 can train/update one or more language models 120 to process multichannel audio data 108. The multichannel audio data 108 can include any type of digital signal that represents an audio recording having two or more channels. An audio channel refers to a single path or stream of digital information that carries an audio signal, such as sound waves captured by a microphone or generated electronically. In the context of multichannel audio data, each channel typically can represent a distinct audio capture device or audio component within an overall audio recording.

One example of multichannel is stereo audio, which includes a left channel and a right channel. Another example includes “surround sound,” such as 5.1 surround sound, which includes audio channels such as left front, center, right front, left rear, right rear, and bass audio channels. In other examples, audio data may be collected from any number of microphones and/or microphone arrays distributed within an environment in any configuration/orientation. In one example, multichannel audio data can include multiple individual “tracks” that are combined to create a mixed audio signal. Each audio channel in the multichannel audio data 108 may have its own unique characteristics, such as gain levels, frequency response, and/or spatial location within a three-dimensional space.

The multichannel audio data 108 can include any number of multichannel audio samples, each of which may be stored in a corresponding file or data structure. Any suitable format may be used to store the multichannel audio data 108, including but not limited to WAV files, audio interchange file format (AIFF) files, MPEG Audio Layer 3 (MP3) files, broadcast wave format (BWF) files, advanced audio codec (AAC) files, or free lossless audio codec (FLAC) files, among others. Each sample of the multichannel audio data 108 may be stored in association with various metadata, including characteristics such as the number of audio sources, information regarding how the multichannel audio sample was generated, a text-based description of the multichannel audio sample, or other information relating to the multichannel audio sample. In some implementations, multichannel audio data 108 can be received by the data processing system 102 from the client device 122, and subsequently stored in the storage 106 for processing according to the techniques described herein.

A sample of multichannel audio data 108 can be captured using any type of suitable equipment. In one example, a sample of multichannel audio data 108 can be captured using one or more microphone arrays. A microphone array can include a configuration of microphones or other devices capable of capturing sound, which are arranged in a particular configuration to capture audio from multiple directions. Each signal captured using a microphone of the microphone array can be stored as a respective audio channel in the sample of multichannel audio data 108. Example configurations of microphone arrays can include but are not limited to linear arrays, circular arrays, or spherical arrays, among others.

The multichannel audio data 108 can, in some implementations, be stored in an ambisonics format, which is sometimes referred to herein as “B-format” audio. B-format audio data is a type of multichannel audio represented as a three-dimensional sound field. B-format audio can include four channels: W (omni), X (front-back), Y (left-right), and Z (up-down). In some implementations, audio can be recorded using a multichannel microphone array and transformed into B-format audio data, and subsequently stored as a sample of multichannel audio data 108. In some implementations, ambisonics microphone arrays may be used to directly capture audio data in B-format, which can be stored as part of the multichannel audio data 108.

Unlike other multichannel audio formats, B-format audio includes a fixed number of channels to represent a full sphere of audio. In contrast, other types of multichannel audio such as stereo sound or surround sound may include any number of audio channels, making such formats incompatible with the fixed input of multi-modal language models 120. Other formats may represent audio data in microphone array-specific channel arrangements, making compatibility with language models 120 challenging due to the variety of possible audio formats and microphone arrangements. The use of B-format (e.g., Ambisonics) audio data addresses these limitations by representing multichannel audio in a microphone array-agnostic format. B-format audio uses a fixed number of channels to represent a full sphere of three-dimensional audio in a manner that is agnostic to the devices used to capture the three-dimensional audio.

The use of a fixed number of channels (e.g., the W, X, Y, and Z channels of B-format) enables the multichannel audio data 108 to be directly encoded (e.g., tokenized) and used as input to one or more language models 120, without regard to the type or arrangement of the devices used to capture the multichannel audio data 108. Multichannel audio data 108 can be encoded by a device used to capture the audio data (e.g., the client device 122) or by the data processing system 102. In some implementations, a microphone array-specific transformation function can be used to convert audio signals captured using the microphone array to B-format audio for inclusion in the multichannel audio data 108. Multichannel audio data 108 can be used to train/update the language models 120 according to the techniques described herein

In some implementations, the multichannel audio data 108 can include higher-order ambisonics (sometimes referred to as higher-order B-format), rather than general four-channel B-format audio data. Higher-order B-format can include an extension of traditional B-format data that provides higher-precision capture and reproduction of spatial information in a sound field. Higher-order B-format may be captured, for example, using additional microphones to record higher-order coefficients that describe the characteristics of the recorded sound field beyond those captured by a standard B-format microphone array.

The number of audio channels in higher-order B-format can depend on the particular order of the B-format audio. For example, the number of channels can increase quadratically with the order (N) of the B-format data. Traditional first-order B-format audio includes four channels, second-order B-format audio includes 9 channels, third-order order B-format audio includes 16 channels, and so on. Language models 120 can include input layers that receive encoded audio data (e.g., encoded audio samples 112, encoded input data 119) generated from any type of B-format audio described herein.

In some implementations, the storage 106 can store different sets of multichannel audio data 108, each of which include a specific order of B-format data (e.g., one corpus of first-order B-format audio, another corpus of second-order B-format audio, etc.). In some implementations, each language model 120 can be trained/updated using a training dataset 110 constructed from multichannel audio data 108 having a particular order (e.g., first-order, second-order, etc.) of B-format. In some implementations, a language model 120 can be trained/updated to process encoded audio generated from multiple orders of B-format data (e.g., both first-order and second-order B-format data, etc.). Training/updating one or more language models 120 can be performed using one or more training datasets 110, as described herein.

The data processing system 102 can use the multichannel audio data 108 to generate a training dataset 110 for one or more language models 120. In some implementations, each training/update sample in the training dataset 110 can include at least one encoded audio sample 112 and corresponding spatial information 114. The encoded audio sample 112 can be an encoded form of a corresponding sample of multichannel audio data 108. Each encoded audio sample 112 can be encoded into a format that is compatible with the one or more language models 120. In some implementations, the data processing system 102 can generate an encoded audio sample 112 using one or more tokenizers 118. The tokenizer(s) 118 used to generate the encoded audio sample 112 can correspond to, and may form a part of, the language model 120 that is to be trained using the corresponding training dataset 110.

The tokenizer(s) 118 can include one or more audio tokenizers, which can encode microphone array-agnostic spatial audio (e.g., B-format/ambisonics audio) into a format compatible with one or more language models 120. In some implementations, the tokenizer(s) 118 can be executed by the data processing system 102 to encode each channel of B-format audio in a sample of multichannel audio data 108. For example, as described herein, first-order B-format audio data can include four channels: W, X, Y, and Z. To tokenize first-order B-format data, each channel of the sample of multichannel audio data 108 can be separately encoded using a corresponding audio codec model.

In one example, each audio codec model may include a non-autoregressive convolutional encoder-quantizer-decoder model for audio codec extraction. Such audio codec models may include any number of convolutional layers, recurrent layers, or other machine-learning layers that are capable of encoding one or more windows of audio data. The audio codec model may be trained or otherwise utilized to process a specific channel of the first order (or higher-order) B-format audio data. Encoding a sample of multichannel audio data 108 can include providing each channel of the sample as input to a respective audio codec model to generate a sequence of output tokens each corresponding to a respective timestep in the audio data for a given channel. Furthering the example above, each timestep would result in four tokens, with one token corresponding to the W channel, a second token corresponding to the X channel, a third token corresponding to the Y channel, and a fourth token corresponding to the Z channel. Further tokens may be generated for a given timestep using audio codec models for higher-order channels, in some implementations.

A token generated by an audio codec model can encode any information represented in the audio in the corresponding timestep. Sequences of tokens generated from an entire sample of multichannel audio data 108, when provided in order, can represented the sample in an encoded format. Each token may include a numerical representation of the audio information in a given channel for a given timestep. In some implementations, multichannel audio tokens can be generated by concatenating or otherwise grouping the tokens generated from a sample of multichannel audio data for a given timestep. Sequences of multichannel audio tokens representing a sample of multichannel audio data 108 can be stored as an encoded audio sample 112 as part of a training dataset 110.

Each encoded audio sample 112 of a training dataset 110 can be stored in with corresponding spatial information 114. In some implementations, each encoded audio sample 112 may also be stored in association with corresponding additional media information 115. Spatial information 114 may include text information that indicates various spatial characteristics of the audio stored as the encoded audio sample 112 in the training dataset 110. For example, the spatial information 114 can include information relating to one or more audio sources represented in the audio sample, including but not limited to a number of directional sources, an azimuth/elevation of each source, and/or a distance to each source, among others. In another example, spatial information may include information relating to speakers (e.g., individuals speaking) in the audio sample, including but not limited to a number of individuals speaking in the audio sample (e.g., a number of speech sources), a transcription of a speaker with respect to a given direction (e.g., a transcription of any speaker in the left, right, up, or down directions, etc.), among others.

The spatial information 114 may include characteristics of different sources of audio, including but not limited to the relative volumes of different sources represented in the encoded audio sample 112, changes in pitch of different sources represented in the encoded audio sample 112, changes in location/direction of different sources represented in the encoded audio sample 112, general attributes (e.g., timbre, classification, duration, intonation, etc.) of different sources represented in the encoded audio sample 112, and/or any other possible spatial characteristic of the corresponding audio sample.

In some implementations, the spatial information 114 may be represented as text data, which can be used as corresponding target output of a multi-modal language model 120. For example, the training dataset 110 may include task-specific training/update examples for language model(s) 120, which are used to train/update the language model(s) 120 to perform task-specific operations with respect to spatial audio. Furthering this example, the spatial information 114 may include text data may that represents an input prompt (e.g., a text-based request or prompt) and/or an output prompt representing a desired response that a language model 120 is to generate based on the input prompt. This can be any type of text data that completes a corresponding input prompt. In one example, an input prompt may include “Count the number of audio sources in the audio sample,” and the output prompt may include “There are three audio sources in the audio sample.” In the foregoing example, the spatial information 114 includes an indication that a corresponding encoded audio sample 112 includes three separate audio sources. Similar prompts may be provided as part of the spatial information 114 for any type of task specific to spatial audio.

For example, input/output prompt pairs may be included in the training dataset 110 in association with corresponding encoded audio samples 112 for directional transcription, such as “Transcribe the speaker speaking from the left,” or “Transcribe the speaker speaking from the right.” Furthering this example, the corresponding output prompts may be a transcript of the speaker that is most prominently heard from the left portion and the right portion of the corresponding spatial audio encoded as the encoded audio sample 112. Various other input/output prompt pairs can be provided as part of the spatial information 114 of one or more training/update examples, for example, that model user requests paired with corresponding outputs to be learned by the language model(s) 120 according to the techniques described herein.

In some implementations, an encoded audio sample 112 of a training dataset 110 can include additional media information 115, which can include any type of output text, video, audio, image, or other information that is to be generated by the language model 120. As described herein, the language model 120 can be a multi-modal model capable of ingesting and/or generating media of various modalities. Such modalities may include but are not limited to text data, audio data, image data, video data, or combinations thereof. In some implementations, additional media information 115 of a training/update example of the training dataset 115 can be generated to include output audio data that is to be generated by a trained/updated language model 120.

In one example, output audio data may include isolated audio of a speaker having a discernable spatial location represented in an encoded audio sample 112. Furthering this example, the spatial information may include text input/output prompts requesting transcription and isolation of one of many speakers in the encoded audio sample 112. The additional media information 115 may include an encoded representation (e.g., a sequence of tokens) of audio including the requested isolated speaker, and the spatial information 114 can include a text output prompt including the transcription of the isolated speaker.

In another example, output audio data in the additional media information 115 of a training/update example can include spatial audio (e.g., tokenized B-format audio) generated as a response or reply to input text or input audio prompt information. For example, in some implementations, the encoded audio sample 112 may be instructions from a user describing a query or describing output that is to be generated by the language model 120. The additional media information 115 for this type of training/update example can include encoded audio data that represents the output that the language model 120 is to generate based on the input query in the encoded audio sample 112. In some implementations, an input text prompt may further specify parameters of the generation of spatial audio. As the encoded output in the training/update example is multichannel audio data, a user can request generation of any desired spatial characteristics of the output, including locations, movement, or directions of one or more audio sources.

The data processing system 102 can generate training datasets 110 that may be used to train/update language model(s) 120 to process requests made by users in audio data (e.g., recorded using one or more microphones or capture devices). For example, training/update examples in the training dataset 110 can include examples where one or more speakers are moving relative to the device that recorded the corresponding sample of multichannel audio data 108. Such encoded audio samples 112 may include background noise or other speakers that are to be differentiated from the moving speakers. In one example, the spatial information may include input/output prompts requesting and providing a transcription and/or diarization output of the moving speaker, such that the language model(s) 120 can learn to differentiate the moving speaker from other noises or speakers in an environment. Such training examples can be useful to enable language models 120 to automatically resolve confusion when multiple speakers are present or when a speaker is moving relative to a multichannel recording device.

Various training/update examples can be included to train/update the language model(s) 120 to track or otherwise attend to user requests in audio data that are moving, for example, in the presence of fixed audio sources from an environment. Training/updating the language model(s) 120 to accurately capture, transcribe, or otherwise respond to user requests in such audio data facilitates the use of language model(s) 120 in connection with audio captured in noisy or dynamic environments.

In some implementations, additional media information in training/update examples of a training dataset 110 can include video data that corresponds to an encoded audio sample 112. In one example, the video data may be encoded/tokenized video data that depicts objects or events that correspond to sound sources of the encoded audio sample 112. Furthering this example, the encoded video data may be used as input data when training/updating the language model(s) 120 to generate the corresponding encoded audio sample 112. Training datasets 110 can be generated to provide generative capabilities for spatial audio, such that the language model(s) 120 are trained/updated to generate three-dimensional audio data that corresponds to, and is synchronized with, video data. Spatial information 114 for such audio samples may include indications of a location of one or more sound sources in the video data, in some implementations. In some implementations, spatial information 114 may not necessarily be included in such training/update examples, enabling the language model(s) 120 to learn to map changes in object/event position in video data to locations of sound sources in output audio, using the corresponding encoded audio samples 112 as ground truth output data.

In another example, the encoded audio data sample 112 can include monophonic audio (e.g., having a single source). The additional media information 115, as well as the spatial information 114, can specify relative locations at which one or more sound sources represented in the monophonic audio are to be represented in output spatial audio. Furthering this example, such training/update examples may include an encoded monophonic audio sample to be used as input for the language model(s) 120, and a corresponding encoded audio sample 112 representing spatial audio that is to be generated by the language model(s) 120.

Training/update examples in the training dataset 110 may also include examples for improving audio quality using the generative capabilities of the language model(s) 120. In one example, an encoded audio sample 112 may include single channel or multichannel audio data having relatively poor quality—including but not limited to noisy background, audio artifacts, or distortion, among other disturbances. Video/image/sensor (e.g., LiDAR, RADAR, sonar, ultrasonic, etc.) data may also be included, for example, to visually represent different sound sources of the input encoded audio sample 112. Furthering this example, the additional media information 115 of the training/update example can include encoded audio data having improved spatial quality. The improved audio data can be used during updates/training of the language model(s) 120 as a comparison to the data that the language model(s) 120 is to generate. The improved encoded audio data can represent spatial audio without distortions, artifacts, or noise. The improved encoded audio data may have improved spatial mapping between sound sources, as indicated in any input video data. Such training/update examples may be generated, in some implementations, by synthetically reducing quality of spatial audio (which may correspond to video data).

Additional training/update examples included in the training dataset 110 may include training examples for virtual, augmented, and/or mixed reality systems. In one example, encoded audio samples 112 can be generated based on audio captured from one or more virtual reality or augmented reality headsets or equipment. Such audio samples may include sound from different environments, which may include different objects, speakers, or environmental hazards. Such training/update examples may be used to discern the speech of a user of a virtual or augmented reality systems in noisy or dynamic soundscapes. In such implementations, such training/update examples of the training dataset 110 can include similar spatial information 114 as described herein (e.g., text data, request information, output responses, etc.), or may include audio responses to be generated by the language model(s) 120, as described herein.

Further training/update examples can include examples to train/update the language model(s) 120 to generate spatial audio for accessibility purposes (e.g., in an augmented reality or a virtual reality context). For example, training/update examples can include input video data for the language model(s) 120 paired with corresponding output encoded audio samples 112 that provide auditory warnings or indications in an environment. In another example, training/update examples in the training dataset 110 can include examples in which spatial audio from an augmented reality device, a virtual reality device, or an accessibility device (e.g., smart glasses, hearing equipment, etc.) can be used to train/update the language model(s) 120 to generate visual indications of oncoming obstacles, environmental hazards, or other objects in the environment. Ground truth data corresponding to said indications may be provided as part of the spatial information, and may include directional notifications, warning signals, or alerts that indicate potential hazards detected in the corresponding encoded audio sample 112 of the training/update example.

The data processing system 102 can generate any number of training datasets 110 to achieve any of the training/update objectives described herein. To generate a training dataset 110, the data processing system 102 can receive or otherwise access various samples of multichannel audio data 108 in the storage, and can associate said samples with corresponding spatial information 114 and/or additional media information 115. In some implementations, the spatial information 114 and/or the additional media information 115 may be retrieved from one or more data sources corresponding to the multichannel audio data 108. In some implementations, one or more of the spatial information 114 and/or the additional media information 115 may be generated using synthetic data generation techniques. Such techniques may include the execution of generative artificial intelligence models, including large language models or vision language models.

In some implementations, one or more samples of multichannel audio data 108 may be received from one or more external computing devices, such as a client device 122, in communication with the data processing system 102. Spatial information 114 and/or additional media information 115 may also be provided by external computing systems, or may be generated using other techniques, such as manual generation/annotation. Various combinations of techniques can be used to generate spatial information 114 and/or additional media information 115 for samples of multichannel audio data 108.

To generate a training dataset 110, the data processing system 102 can use one or more tokenizer(s) 118 to generate encoded audio samples 112 for each sample of multichannel audio data 108 provided for the training dataset 110. Doing so may include providing each channel of the multichannel audio data 108 as input to a corresponding model trained/updated to generate a sequence of output tokens each corresponding to a respective timestep in the audio data for a given channel, as described herein. The sequences of tokens for each channel may be combined into one or more data structures to correspond to the encoded audio sample. In some implementations, the data processing system 102 can execute similar tokenizers to tokenize various other media that is to be provided as input to the language model(s) 120 during training. Such tokenizers 118 may include video tokenizer models that are trained/updated to tokenize one or more frames of video data prior to initiating an input sequence, or text-based tokenizers that are trained/updated to segment and tokenize text data included in the spatial information 114 and/or the additional media information 115 of each training/update example in the training dataset 110.

Once the data has been tokenized, the data processing system 102 can store the encoded audio samples 112 in association with corresponding spatial information 114 and/or additional media information 115, in one or more data structures. Each group including an encoded audio sample 112, spatial information 114, and/or additional media information 115 may be stored in association with an identifier of the training/update example to which it corresponds. In some implementations, the training dataset 110 can be stored in association with an identifier of a training/update objective for the training dataset 110 (e.g., to train/update the language models 120 to learn spatial relationships, to isolate speakers represented in audio data, to generate spatial audio for video data, to generative improved audio/spatial quality according to audio/text input, etc.). In some implementations, the data processing system 102 can generate multiple training datasets 110 for multiple training/update objectives. In some implementations, the data processing system 102 can generate a training dataset 110 to include training/update examples for multiple training/update objectives.

As shown, the data processing system 102 can maintain, execute, and train/update one or more language models 120. The language model(s) 120 can include any type of multi-modal language model capable of processing natural language text input, audio input, video input, or image input, among other media modalities. The language model(s) 120 may be or include a transformer-based model (e.g., a generative pre-trained transformer (GPT) model). The language model(s) 120 may be or include a large language model (LLM) or a vision language model (VLM), in some implementations. In some implementations, the language model(s) 120 may one or more tokenizers 118, which are capable of converting media data into an encoded format (e.g., one or more tokens, or a “tokenized” format) that is compatible with the layers of the language model(s) 120.

In some implementations, the data processing system 102 can maintain, store, update, and/or deploy multiple language models 120. For example, different language models 120 may include different media processing capabilities (e.g., one language model 120 can process video data, another language model 120 model can process audio and text data, etc.). In some implementations, different language model(s) 120 can be trained/updated according to different training/update objectives by using one or more corresponding training dataset(s) 110.

The data processing system 102 can use the model updater 116 to train/update a language model 120. The language model 120 may be trained/updated, in one example, in response to a corresponding request received from an external computing device or in response to input received from an operator of the data processing system 102. The model updater 116 can include any software, hardware, or combinations thereof to perform training/update operations of the language model(s) 120 as described herein. The request to train/update the language model 120 may indicate one or more training datasets 110 to use in training/updating the language model(s) 120. In some implementations, the training datasets 110 can be automatically identified or otherwise selected based on one or more training/update objectives specified in the request (e.g., by selecting training datasets 110 having a training/update objective that matches that specified in the request, etc.).

To train/update a language model 120 using a training dataset 110, the model updater 116 can iterate through each training/update example in the training dataset 110 according to hyperparameters (e.g., number of epochs, batch size, etc.) of the training/update process, which may be specified via the request to train/update the language model 120 or via configuration settings. For each training/update example, the model updater 116 can generate a context for the language model 120 to be trained. Generating the context may include concatenating the tokenized input data (e.g., the encoded audio sample 112, any encoded additional media data 115, encoded text prompt data, etc.) with encoded output data into a single sequence. The start and end of media modalities may be specified with special encoded tokens in the input context, such that the language model 120 can learn to delineate different types of input data. In some implementations, positional encodings or other relevant embeddings can be added to the context to preserve the order of certain input/output data in the sequence, and to differentiate between the input and output segments of the context.

The model updater 116 can then apply an attention mask (e.g., cross attention, self attention, etc.) to the context, such that the language model 120 is to attend only to the encoded input data (e.g., input tokens). The attention mask may include replacing masked tokens with a special token that indicates said encoded data should not be attended to. Masked data in the context can be data that the language model is to predict during training. Such attention masks can direct the language model 120 to use the encoded input when predicting each token in the output sequence. Attention masks may be applied in any suitable masking pattern. In some implementations, an attention mask can be applied to the encoded data in the generated context representing the output data that the language model 120 is to generate. For example, if the language model is being trained/updated for a generative task, an attention mask can be applied to tokens in the context representing the output audio data (e.g., an encoded audio sample 112 used as ground truth data).

In a training/update iteration, the model updater 116 can execute the language model 120 by passing the sequence of encoded data of the context through each layer of the language model 120 while performing mathematical/machine-learning operations of each layer. The output of the language model 120 can include a distribution of candidate token outputs, from which one or more output tokens are selected. The output can be predicted autoregressively, in some implementations, where the model updater 116 appends the predicted output token to the initial context to generate an extended context. The extended context is then provided as input to the language model 120 until all of the output tokens have been predicted. In some implementations, a “teacher forcing” technique can be used, in which the ground truth tokens from the output portion of the context sequence (rather than the model's own predictions) are appended to the initial input context for predicting the next token. In some implementations, the language model 120 may generate tokens non-autoregressively, where the language model 120 is executed to predict all tokens of the output simultaneously.

In some implementations, the language model 120 can autoregressively generate multiple output tokens. For example, the language model 120 can include layers that output a predicted token for each channel of a single timestep of B-format audio simultaneously. For example, in first order B-format audio, the language model 120 can simultaneously generate output tokens for each of the W, X, Y, and Z channels for a single time step. A greater number of tokens may be simultaneously generated for higher order B-format audio, in some implementations. In some implementations, the language model 120 may only autoregressively generate a single token per iteration.

The model updater 116 can compare the ground truth tokens of the training/update examples to each output token predicted by the language model 120 using a loss function, such as a cross-entropy loss function, to quantify the difference between the predicted and actual tokens. In one example where cross-entropy loss is used, the model updater 116 can compare the predicted probability distribution (e.g., the softmax function) output by the language model 120 to a one-hot encoded true distribution representing the actual next token(s) in the output sequence. The model updater 116 can calculate the cross-entropy loss as the negative log probability of the ground truth token according to the predicted distribution of the language model 120. The model updater 115 can calculate the total loss for the training/update sequence as the sum (or some implementations, the average) of the cross-entropy losses over all token positions in the output sequence predicted by the language model 120. Similar approaches may be used to calculate other types of loss functions, in some implementations.

The model updater 116 can use backpropagation techniques to train/update the parameters of the language model 120 using the computed loss. Backpropagating can involve calculating gradients of the loss with respect to each parameter and adjusting the parameters in the direction that minimizes the loss. Parameter adjustment can be performed using a suitable optimization function, such as a gradient descent function or an Adam optimizer function. The model updater 116 can iteratively repeat this process with a number of training/update examples of the training dataset(s) 110 until a training/update termination condition has been reached, such as an accuracy threshold being met or upon using a predetermined number of training/update examples to train/update the language model(s) 120.

As described herein, training/update examples can be provided for training/updating the language model 120 to achieve a variety of objectives. In some implementations, the training/update examples can be provided to train/update the language model 120 to generate output text data indicating various spatial properties of one or more audio sources represented in input multichannel audio. For example, output text may identify a distance to the audio source represented in the input multichannel audio, a number of audio sources represented in the input multichannel audio, or a transcription of speech from a moving audio source represented in the input multichannel audio.

In some implementations, the language model 120 can be updated to process spatial audio for generative tasks. For example, the model updater 116 can use training/update examples of one or more training datasets 110 to update the language model 120 to generate output multichannel audio from input audio. Such objectives may include noise reduction, spatial quality improvement, or converting single channel audio into multichannel audio according to instructions or input video data, as described herein. In an example where video/image/sensor data is used, the training/update examples can include encoded representation of video/image/sensor data (e.g., as part of the additional media information 115, etc.), and the model updater 116 can use the encoded representation of the video/image/sensor data as part of the input sequence in the generated context for the training/update example. The model updater 116 can generate the context such that ground truth output data includes encoded multichannel audio (e.g., an encoded audio sample 112), which represents audio tracking of at least one audio source depicted in the video/image/sensor data. For example, the video/image/sensor data may depict a traveling from left to right, and the corresponding encoded audio sample 112 can be an audio sample of a train noise moving from the left direction to the right direction, synchronized with the video/image/sensor data.

In another example, the training/update examples can include encoded representation of video/image/sensor data (e.g., as part of the additional media information 115, etc.), and the model updater 116 can use the encoded representation of the video/image/sensor data as part of the input sequence in the generated context for the training/update example. Additionally, the input context can include encoded single channel audio data that corresponds to and is synchronized with the video/image/sensor data. To enable the language model 120 to learn to convert single channel audio to multichannel audio for a video, the model updater 116 can generate the context such that ground truth output data includes encoded multichannel audio (e.g., an encoded audio sample 112), which represents the multichannel version of the input single channel audio, as synchronized with the video/image/sensor data. Similar approaches may be used to train/update the language model according to any suitable objective with any type of multi-modal data relating to multichannel audio.

Once trained/updated, the language model 120 can be executed to generate model output 126 in response to receiving input prompts (e.g., the input data 124) from one or more client devices 122, in some implementations. The system 100 is shown as including a client device 122, which may include one or more input/output device(s), such as microphones, video/image/sensor data capture devices (e.g., integrated cameras, LiDAR, RADAR, ultrasonic, sonar, etc.), and text input devices (e.g., touchscreens, keyboards, AR/VR/MR devices, gesture recognition systems, etc.). The client device 122 can include any type of device that is capable of communicating with the data processing system 102 (e.g., via one or more networks), including but not limited to smartphones, laptop or mobile computers, augmented and/or virtual reality devices, digital assistant devices, accessibility devices (e.g., hearing aids or equipment, etc.) personal computers, servers, cloud computing systems, in-vehicle or in-cabin infotainment systems, or other types of computing systems that can provide input data 124 to the data processing system 102. In some implementations, the client device 122 can include one or more communications interfaces that enable transmission of input data 124 to one or more external computing systems, which may include the data processing system 102.

The input data 124 can include any type of data that can be provided as input to the one or more language models 120, including but not limited to text data, multichannel audio data, single channel audio data, video data, image data, sensor data, 2D or 3D design or graphics data, among others. In some implementations, the input data 124 can be captured via one or more input devices of the client device 122. In some implementations, the input data can be stored in one or more data structures at the client device 122. In some implementations, the client device 122 can execute one or more applications that enable a user to provide text input, capture audio, or capture video to provide as input to the language model 120. Such applications may include augmented reality or virtual reality applications, in some implementations. In some implementations, the application may include a frontend for a conversational agent.

Input data 124 generated or retrieved by the client device 122 can be transmitted to the data processing system 102, for processing using the trained/updated language model 120. In some implementations, the input data 124 can be provided via input by an operator of the data processing system 102. Upon receiving the input data 124, the data processing system 102 can execute one or more tokenizers 118 (e.g., each corresponding to a respective channel of multichannel audio data, or to a different media modality, etc.) to generate encoded input data 119. The encoded input data 119 can include one or more sequences of tokens representing the input data 124 in a numerical format compatible with the input layer(s) of the trained/updated language model 120.

For example, if the input data 124 includes B-format audio data, the data processing system 102 can execute tokenizers 118 that convert each channel of the B-format audio into a sequence of tokens, which can be formatted into an input context for the language model(s) 120 as described herein. Further, tokenizer(s) 118 may be executed to convert other types of media into an encoded format for inclusion in the encoded input data 119. Generating the encoded input data 119 can included generating encoded video data using a video-specific tokenizer 118, generating encoded text data using a text-specific tokenizer 118, or generating encoded single channel audio data using a tokenizer 118 specific to processing single-channel audio. In some implementations, the data processing system 102 can update the encoded input data 119 to include additional tokens marking the beginning and end of different sequences corresponding to different media modalities. For example, the data processing system 102 can provide respective start/stop tokens for sequences of encoded audio data, sequences of corresponding encoded text data, and/or sequences of encoded video data.

Once the encoded input data 119 has been generated, the data processing system 102 can execute the language model 120 by providing the encoded input data 119 to the input layer(s) of the language model 120. The data processing system 102 can perform the mathematical operations of each layer of the language model, propagating the results of each layer to the next layer for processing until one or more output distributions of token probabilities is generated (e.g., from an output softmax layer, etc.). The data processing system 102 can use one or more configuration settings to select one or more tokens from the output distribution(s) for inclusion in output response. The data processing system 102 can execute the large language model 120 autoregressively, to model sequences of output tokens corresponding to one or more media modalities, including multichannel (spatial) audio data, video data, and/or text data. For example, the data processing system 102 can execute the language model 120 to predict one or more next tokens in an output sequence, which can then be included in the input context for the next iteration, as described herein.

The data processing system 102 can execute the language model 120 iteratively, incorporating previously generated tokens as context for generating subsequent tokens, until a termination condition has been reached. One type of termination condition can be a context length limit or a configurable limit on the number of tokens that can be generated and/or processed by the language model 120. In some implementations, the termination condition can be satisfied when the language model 120 generates a token that represents the end of a response. The language model 120 may be trained/updated to be a conversational agent, in some implementations. For example, the language model 120 can generate realistic natural language in response to natural language input, which may take the form of audio data representing natural human speech.

Once the termination condition for executing the language model 120 has been detected, the data processing system 102 can convert the encoded output generated by the language model 120 into a decoded format for transmission to the client device. In some implementations, this can include performing an inverse operation from the tokenization process. For example, in some implementations, the tokenizer(s) 118 can include one or more detokenizer models that are trained/updated to convert numerical tokens generated by the language model 120 into corresponding media modality. In one example, the data processing system 102 can execute tokenizer models that convert sequences tokens representing channels of B-format audio into a B-format audio sample.

Similar operations can be performed by the data processing system 102 to generate decoded text data and/or video data, for inclusion in the model output 126. For example, text data can be generated by detokenizing the text-specific tokens generated using the language model 120, and video data can be generated by detokenizing the video-specific tokens generated using the language model 120. Media specific tokens can be extracted, in some implementations, according to media-type-specific start/stop sequence tokens generated by the language model 120. Output text, video, and/or audio generated by the language model 120 can be provided as part of the model output data 126.

The model output 126 can include text data generated using the large language model 120, which may include text-based responses generated according to input multichannel audio sample(s). For example, the text data may specify data indicative of spatial information of audio in the model, including but not limited to a distance to one or more audio sources represented in the input audio, a number of audio sources represented in the input audio, or a transcription of speech from a moving audio source represented in the input audio.

The model output 126 may include multichannel audio data 108 generated by the language model 120. In one example, the data processing system 102 can provide encoded video data in addition to audio data as input to the language model (e.g., as part of the encoded input data 119), and generate output indicative of spatial information based on the input audio and video. Furthering this example, the input audio may include single channel audio, and the data processing system can generate multichannel audio as output that converts the single channel audio into multichannel, spatial audio. The spatial audio can include the content of the single channel audio correctly mapped in a three-dimension sound space to track of at least one audio source depicted in the video data. For example, the video may depict a traveling from left to right, and the corresponding output audio can include an audio sample of a train noise (represented in the single channel audio) moving from the left direction to the right direction, synchronized with the video.

Similar approaches may be used to generate model output 126 including audio samples having improved audio quality. In some implementations, spatial/multichannel audio captured using end-user devices (e.g., smartphones, etc.) may have poor sound/spatial quality. The data processing system can execute the language model 120 using the input, poor-quality audio as input to generate output multichannel audio samples having improved spatial quality (e.g., attenuating distortion and background noise, amplifying audio in the direction of a speaker, etc.). In some implementations, the model output 126 may include one or more alerts or messages indicating potential hazards detected in input audio data, for use in accessibility-based devices such as visual accessibility devices or augmented/virtual/mixed reality devices for hearing-impaired individuals.

The model output 126 may be provided the client device 122 for presentation to a user. In one example, text data in the model output 126 can be displayed in one or more applications executing on the client device 122 (e.g., using a display of the client device 122). Audio data included in the model output 126 may be transmitted to the client device 122 such that it can be played via one or more audio-output devices, such as integrated speakers of the client device 122. Video data transmitted as part of the model output 126 can be presented (in connection with any associated audio data) via one or more display devices of the client device 122, in some implementations. Any model output 126 transmitted to the client device 122 can be stored in memory of the client device 122, for later access or processing. In some implementations, the model output 126 can be stored in memory of the data processing system 102, in association with input data 124. This information can be used in generating future training datasets 110, for example, using reinforcement learning techniques, in some implementations.

In some implementations, the client device 122 or the data processing system 102 can store/maintain a record of input data 124 and corresponding model outputs 126 in a sequence, such that the data processing system 102 uses the language model(s) 120 to provide a conversational agent. In such implementations, the data processing system 102 can provide one or more web-based interfaces for the conversational agent to the client device 122, via which a user can provide input data 124 using the input/output devices of the client device 122. Using these techniques, the data processing system 102 can train/update and execute language models 120 to process spatial/multichannel audio as a conversational agent.

In embodiments where a conversational agent is deployed using the language model(s) 120, the conversational agent may be deployed as a non-player character (NPC) in a video game, for example, such as a video game locally managed (e.g., using a computing device or a game console) and/or remotely managed using a content streaming platform or service (e.g., NVIDIA's GeFORCE NOW). In other embodiments, the conversational agent may be deployed within a vehicle or other machine type, such as part of an in-cabin infotainment system and/or as a digital assistant within a vehicle or machine (e.g., to aid in control of components and/or features of the vehicle or machine—such as windows, doors, audio/video playback, navigation, etc.). In some embodiments, the conversational agent may be deployed along with a digital avatar, digital human, or robot, to allow the avatar, human, or robot to converse with users in an environment using the spatial awareness identified using the language model(s) 120. In some embodiments, the conversational agent may be deployed on a stationary object such as a screen of a talking/smart kiosk, or may be deployed on a moving object such as a robot. In any example, a rendering of the conversational agent may be generated within a simulation platform and/or a collaborative content generation and sharing platform for digital assets—such as those that use universal scene descriptor (USD) data (e.g., NVIDIA's OMNIVERSE). For example, the rendering of a digital human, digital avatar, etc. may be generated using a simulation platform and streamed for display to an end-user device.

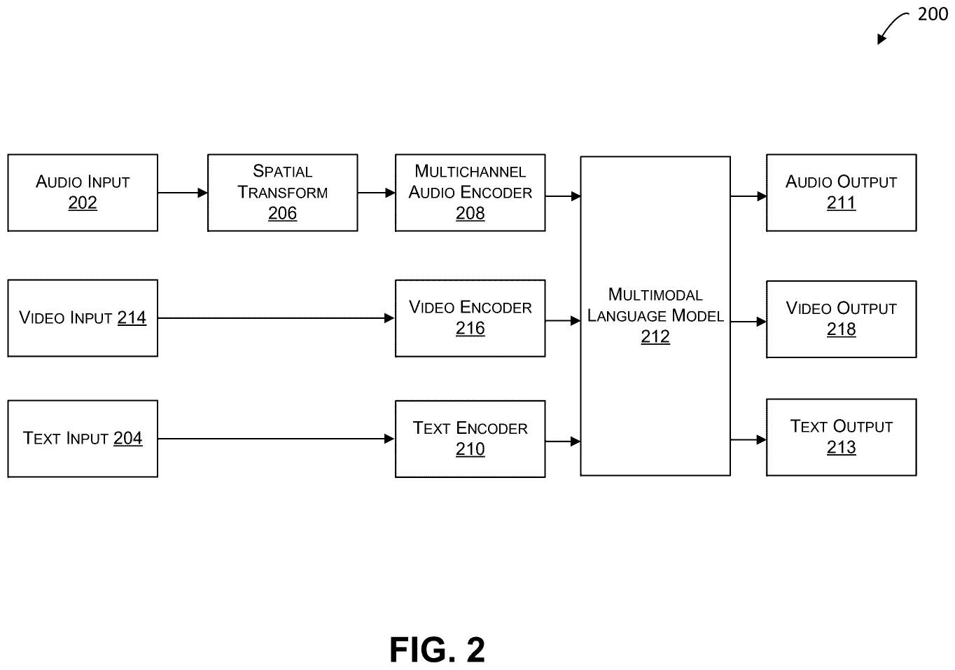

Referring to FIG. 2, illustrated is a dataflow diagram 200 showing how spatially aware audio-augmented conversational agents can be used to process different types of data, in accordance with some embodiments of the present disclosure. The process shown in the dataflow diagram 200 can be performed, for example, by the data processing system 102 of FIG. 1, as described herein. As described herein, multi-modal language models 212 (e.g., the language model(s) 120) can be trained/updated to process different types of spatial audio data and data associated therewith, including but not limited to text input data 204 and video input data 214.

In this example, the multi-modal language model 212 is trained/updated to process audio input data 202, video input data 214, and text input data 204. However, it should be understood that other configurations are also possible, and that the multi-modal language model 212 can be trained/updated to process any type and combination of input data. Furthering this example, the audio input data 202 is multichannel audio data having a format that is different from a B-format audio (e.g., ambisonics audio). To generate B-format audio that is compatible with the multi-modal language model 212, a spatial transform function 206 can be used. The spatial transform function 206 can be specific to the equipment that captured the microphone array. The number of audio channels included in the audio input data 202 can correspond to the number of microphones in the capture device used to capture the audio input 202. The spatial transform function 206 can be a function of the relative distances between each microphone, the gain of each microphone, and other properties of the device used to capture the audio input data 202. In some implementations, the spatial transform function 206 can include multiplying a transformation matrix to the channels of audio in the audio input data 202, to generate a set of output channels of B-format audio.

As shown, once generated by the spatial transformation function 206, the B-format audio (which in some implementations may include higher order B-format audio) can be provided as input to a multichannel audio encoder 208. The multichannel audio encoder 208 can include a set of tokenizers (e.g., a set of tokenizers 118) that are trained/updated to generate an encoded representation of B-format audio output by the spatial transform function 206. For example, each tokenizer in the set of tokenizers can respectively correspond to, and generate encoded data for, a channel of the B-format audio. Furthering this example, a first tokenizer can process signals for the W channel of the B-format audio, a second tokenizer can process signals for the X channel of

B-format audio, a third tokenizer can process signals for the Y channel of B-format audio, and a fourth tokenizer can process signals for the Z channel of B-format audio. Each token output by the tokenizers can correspond to a respective timestep, and when provided in sequence can represent an encoded representation of the audio input data 202 that is compatible with the multichannel audio encoder 208, as described herein.

As shown, the output of the multichannel audio encoder 208 can be provided as input to the multi-modal language model 212, for example, as part of an input context for the multi-modal language model 212. The sequence of tokens representing the encoded audio input data 202 can be identified by special start/stop tokens in the input context, in some implementations. The multi-modal language model 212 can be trained/updated to receive additional data from different media modalities, as described herein. As shown, the multi-modal language model 212 can be trained/updated to receive video input data 214 and text input data 204.

To convert the video input data 214 and text input data 204 into a format compatible with the multi-modal language model 212, the video encoder 216 and the text encoder 210 can be used, respectively. The video encoder 216 can include one or more video tokenizer models (e.g., one of the tokenizers 118) that are trained/updated to generate sequences of tokens representing the video input data 214. The text encoder 210 can include one or more video tokenizer models (e.g., one of the tokenizers 118) that are trained/updated to generate sequences of tokens representing text input data 204. The outputs of the multichannel audio encoder 208, the video encoder 216, and the text encoder 210 can be combined into a single input context for the multi-modal language model 212, as described herein.

The multi-modal language model 212 can be executed (e.g., autoregressively), as described herein, to generate one or more sequences of out tokens. In some implementations, if the multi-modal language model 212 is to generate audio data, the output sequence generated by the multi-modal language model 212 can include special start/stop tokens indicating the tokens that correspond to encoded audio data in the output sequence. In some implementations, if the multi-modal language model 212 is to generate video data, the output sequence generated by the multi-modal language model 212 can include special start/stop tokens indicating the tokens that correspond to encoded video data in the output sequence. In some implementations, if the multi-modal language model 212 is to generate text data, the output sequence generated by the multi-modal language model 212 can include special start/stop tokens indicating the tokens that correspond to encoded text data in the output sequence.

Encoded audio data, video data, and/or text data can be extracted from the output sequence generated by the multi-modal language model 212 according to their corresponding start/stop tokens, and used to generate the audio output data 211, the video output data 218, and the text output data 213, as shown. Generating the audio output data 211, the video output data 218, and the text output data 213 can include providing the encoded audio data, video data, and text data as input to one or more decoders. Each of the decoders can perform the inverse operation of the corresponding encoders (e.g., multichannel audio encoder 208, video encoder 216, text encoder 210), as described herein. In some implementations, one or more decoder model for multichannel audio can decode sequences tokens for each channel of B-format audio, as described herein. Similar approaches can be used to generate the video output data 218 and the text output data 213. The audio output data 211, video output data 218 (which may additionally or alternatively include image, sensor, and/or other data type outputs), and the text output data 213 can be provided as output, for example, as part of a conversational agent application.

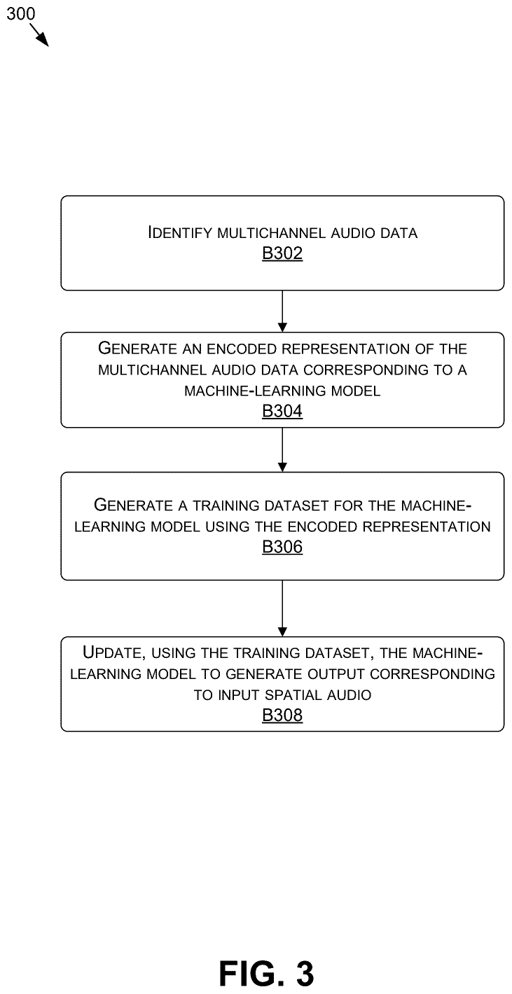

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for training/updating spatially aware audio-augmented conversational agents, in accordance with some embodiments of the present disclosure. The method 300, at block B302, includes identifying multichannel audio data (e.g., the multichannel audio data 108). The multichannel audio data may be received from a client device (e.g., the client system 101) via a network, or retrieved from a data source (e.g., the storage 106). The multichannel audio data can include, but is not limited to, first-order B-format audio or higher-order B-format audio. In some implementations, the multichannel audio data can be identified in response to a request (e.g., from a client device) to train/update one or more language models (e.g., the language model(s) 120). In some implementations, the request may be provided via input to the computing system (e.g., the data processing system 102) performing the method 300. As described herein, the multichannel audio data may be associated with corresponding spatial information (e.g., the spatial information 114) and/or corresponding additional media data (e.g., the additional media data 115).

The method 300, at block B304, include generating an encoded representation (e.g., an encoded audio sample 112) of the multichannel audio data corresponding to a machine-learning model (e.g., the language model 120). The encoded representation can be generated, for example, by executing one or more tokenizer models (e.g., one or more tokenizers 118) associated with the machine-learning model that is to be trained. As described herein, generating an encoded representation of the multichannel audio data can include tokenizing signals from each channel of the multichannel audio data. Tokens for each channel in the same timestep can be combined (e.g., concatenated, etc.), in some implementations. In some implementations, separate tokenizer models can be used to generate the encoded representation for each channel of the multichannel audio data. In some implementations, a single tokenizer model can be used to tokenize all channels of the multichannel audio data.

The method 300, at block B306, includes generating a training dataset (e.g., the training dataset 110) for the machine-learning model using the encoded representation. Generating a training dataset can include generating one or more training/update examples according to one or more training/update objectives, as described herein. For example, training/update examples for enhancing spatial audio quality can include encoded audio data having poor quality as input and encoded audio data having enhanced quality as ground-truth output. Training/update examples for generating multichannel audio data may include text and/or video data as input for the model and output multichannel audio data as ground truth data. Training/update examples for transcription of a moving speaker may include multichannel audio data as input for the model and output text data including the transcription of the moving speaker represented in the multichannel audio data as ground truth data. Any number of training/update examples may be generated to according to any of the training/update objectives described herein.

The method 300, at block B308, includes training/updating the machine-learning model (e.g., the language model(s) 120) using the training dataset to generate output (e.g., model outputs 126) corresponding to input spatial audio. Training/updating the language models described herein can include iterating through each training/update example of the training dataset and constructing an input context for the machine-learning model. Constructing the input context may include concatenating the encoded representations of the input data and ground truth data of the training/update example into a single data structure. Attention masks may be applied to mask the encoded representation of the ground truth output.

In a training/update iteration, the machine-learning model can be executed by passing the sequence of encoded data of the context through each layer of the machine-learning model while performing mathematical/machine-learning operations of each layer. The output of the machine-learning model can include a distribution of candidate token outputs, from which one or more output tokens are selected. The output can be predicted autoregressively, in some implementations, such that the predicted output token is appended to the initial context to generate an extended context. The extended context is then provided as input to the machine-learning model to predict the next token, until all of the output tokens have been predicted. In some implementations, a “teacher forcing” technique can be used, in which the ground truth tokens from the output portion of the context sequence (rather than the predictions of the machine-learning model) are appended to the initial input context for predicting the next token. In some implementations, the machine-learning model may generate tokens non-autoregressively, where the machine-learning model is executed to predict all tokens of the output simultaneously.

The ground truth tokens of the training/update examples can be compared to each output token predicted by the machine-learning model using a loss function, such as a cross-entropy loss function, to quantify the difference between the predicted and actual tokens, as described herein. Backpropagation techniques can then be used to train/update the parameters of the machine-learning model using the computed loss. Backpropagating can involve calculating gradients of the loss with respect to each parameter and adjusting the parameters in the direction that minimizes the loss. Parameter adjustment can be performed using a suitable optimization function, such as a gradient descent function or an Adam optimizer function. The training/update process can be repeated iteratively using different training/update examples of the training dataset until a training/update termination condition has been reached.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Large Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)-such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

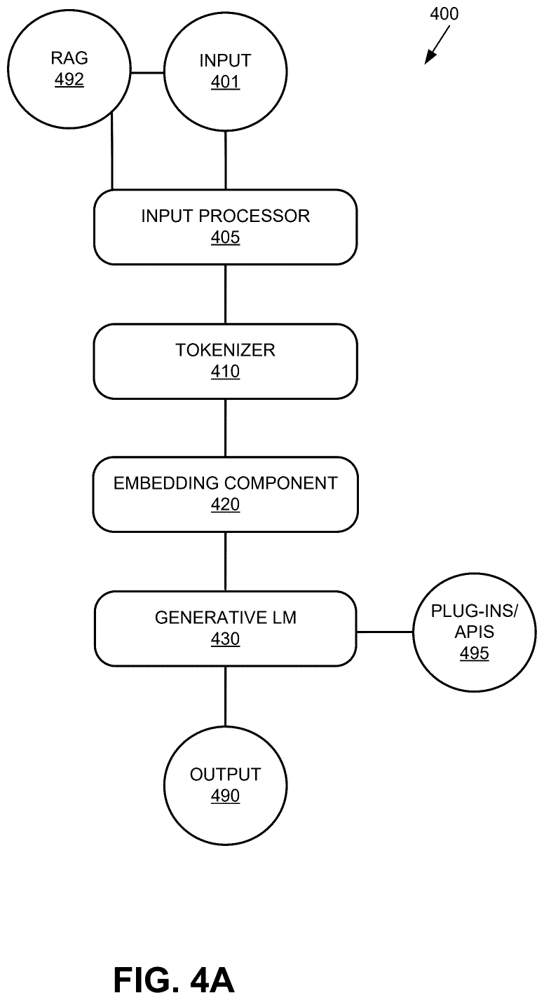

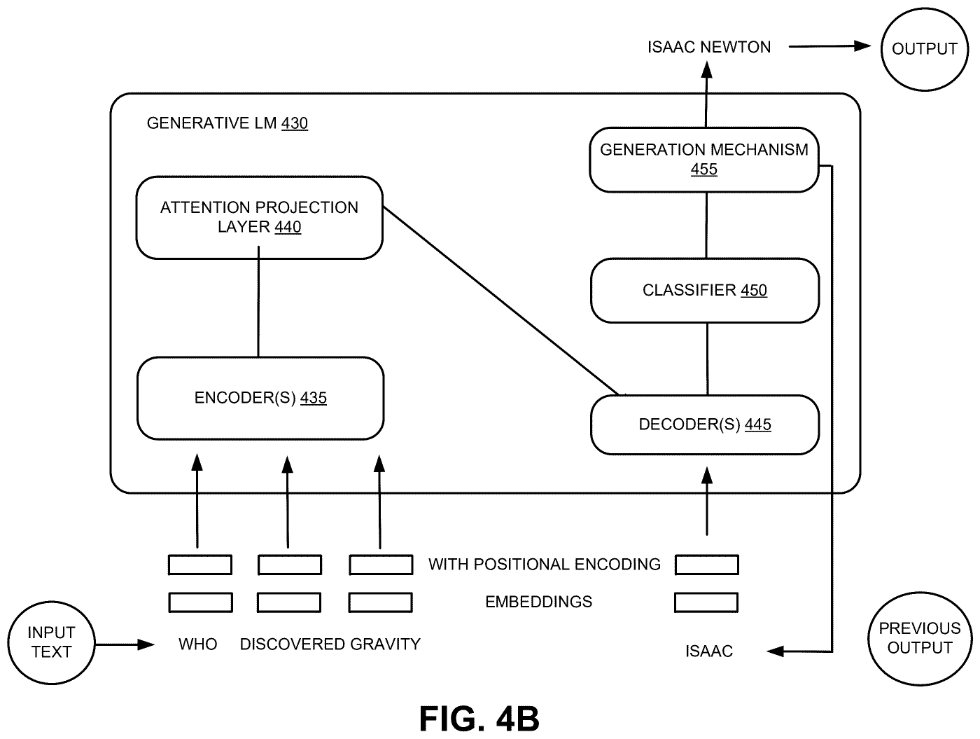

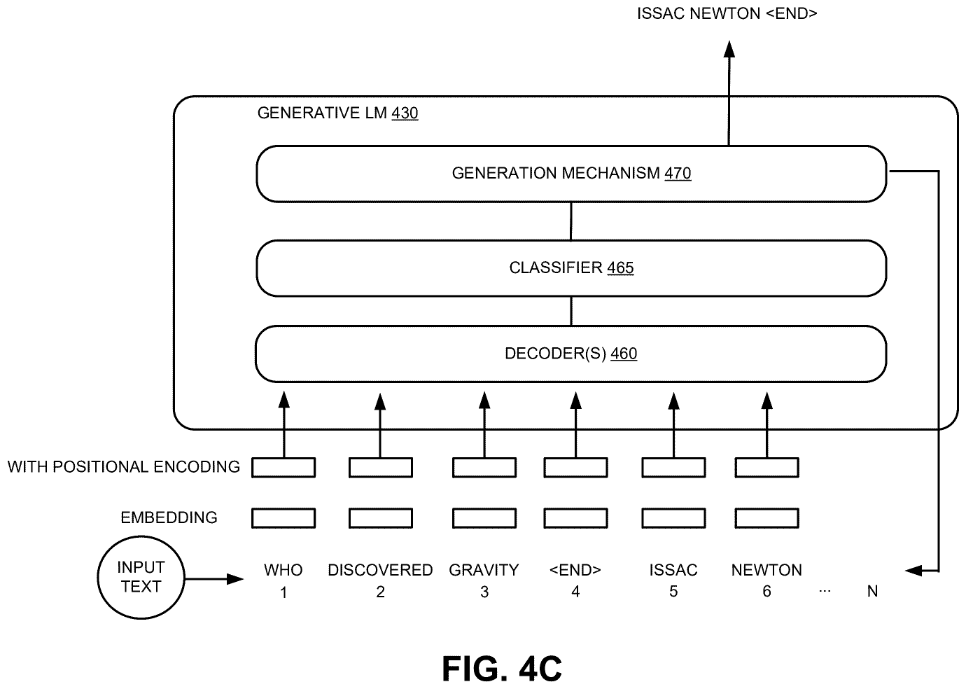

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 430 (e.g., LLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using the generative LM 430 itself) may be used to retrieve additional information to be used as part of the input 401 or prompt. RAG may be used to enhance the input to the LLM/VLM/MMLM/etc. with external knowledge, so that answers to specific questions or queries or requests are more relevant-such as in a case where specific knowledge is required. The RAG component 492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc, or multichannel audio data (e.g., one or more channels of B-format audio, etc.), depending on the implementation. Word-based tokenization divides the text into individual words, treating each word as a separate token. Similar approaches may be used to generate tokens that represent one or more samples of one or more channels of multichannel audio data, as described herein. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features-such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources-such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

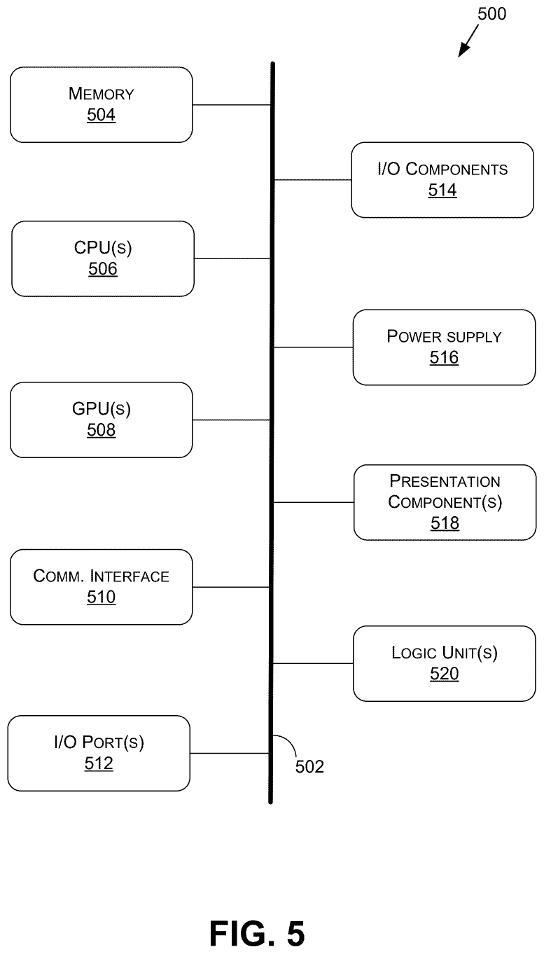

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

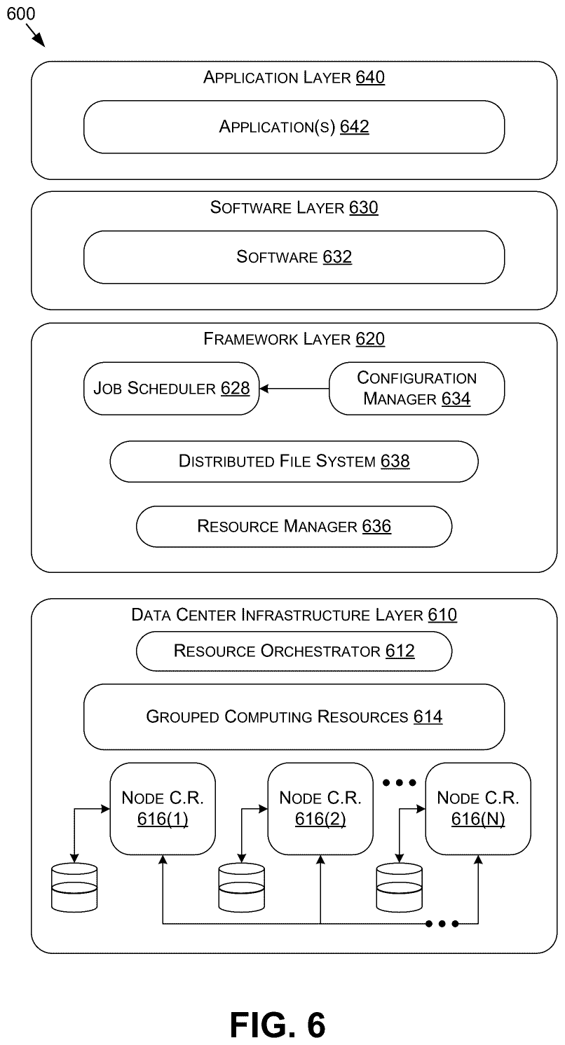

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
generate an encoded representation of multichannel audio data corresponding to a machine-learning model;
generate a training dataset for the machine-learning model using the encoded representation, the training dataset indicating spatial information for at least one audio source represented in the multichannel audio data; and
update, using the training dataset, one or more parameters of the machine-learning model to generate output corresponding to input spatial audio.

2. The one or more processors of claim 1, wherein the machine-learning model comprises at least one of a large language model (LLM), a vision language model (VLM), or a multi-modal language model (MMLM).

3. The one or more processors of claim 1, wherein the spatial information comprises text data, and wherein the one or more circuits are to update the one or more parameters of the machine-learning model to generate output text data relating to at least an audio source represented in the input spatial audio.

4. The one or more processors of claim 3, wherein the output text data identifies one or more of a distance to the audio source represented in the input spatial audio, a number of audio sources represented in the input spatial audio, or a transcription or diarization output of speech from a moving audio source represented in the input spatial audio.

5. The one or more processors of claim 1, wherein the one or more circuits are to generate the multichannel audio data by applying a spatial transform operation to a plurality of audio sources.

6. The one or more processors of claim 5, wherein the spatial transform operation generates the multichannel audio data as B-format audio.

7. The one or more processors of claim 1, wherein the one or more circuits are to update the one or more parameters of the machine-learning model to generate output spatial audio according to the input spatial audio.

8. The one or more processors of claim 1, wherein the one or more circuits are to:
generate the training dataset to include an encoded representation of video data; and
update, using the training dataset, the one or more parameters of the machine-learning model to generate output spatial audio tracking at least one audio source depicted in the video data.

9. The one or more processors of claim 8, wherein the one or more circuits are to update the one or more parameters of the machine-learning model to receive single channel audio data and the encoded representation of the video data to generate the output spatial audio.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a language model;
a system for performing generative AI operations using a large language model (LLM);
a system for performing generative AI operations using a vision language model (VLM);
a system for performing generative AI operations using a multi-modal language model;
a system for generating synthetic data;
a system incorporating one or more virtual machines (VMs);
a system implemented at least partially in a data center; or
a system implemented at least partially using cloud computing resources.

11. A system comprising:
one or more processors to:
receive, from a client device, input audio for a language model trained to process multichannel audio data;
generate, using the input audio and the language model, output data indicative of spatial information of at least one audio source represented in the input audio; and
provide the output data indicative of the spatial information to the client device.

12. The system of claim 11, wherein the one or more processors are to:
generate an encoded representation of the input data for the language model; and
provide the encoded representation as input to the language model.

13. The system of claim 11, wherein the one or more processors are to:
receive input text for the language model; and
generate, using the language model, the output data indicative of the spatial information based on the input text and the input audio.

14. The system of claim 11, wherein the one or more processors are to:
receive input video for the language model; and
generate, using the language model, the output data indicative of the spatial information based on the input video and the input audio.

15. The system of claim 11, wherein the output data comprises an encoded output of the language model, and the one or more processors are to:
generate output multichannel audio based on the encoded output of the language model.

16. The system of claim 11, wherein the output data comprises one or more of a number of sound sources represented in the input audio, an estimated distance of a sound source represented in the input audio, or an estimated location of a sound source represented in the input audio.

17. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a language model;
a system for performing generative AI operations using a large language model (LLM);
a system for performing generative AI operations using a vision language model (VLM);
a system for performing generative AI operations using a multi-model language model;
a system for generating synthetic data;
a system incorporating one or more virtual machines (VMs);
a system implemented at least partially in a data center; or
a system implemented at least partially using cloud computing resources.

18. A method, comprising:
generating, using one or more processors, an encoded representation of multichannel audio data corresponding to a machine-learning model;
generating, using the one or more processors, a training dataset for the machine-learning model using the encoded representation, the training dataset indicating spatial information for at least one audio source represented in the multichannel audio data; and
updating, using the one or more processors and the training dataset, one or more parameters of the machine-learning model to generate output corresponding to input spatial audio.

19. The method of claim 18, wherein the spatial information comprises text data, and wherein the method further comprises updating, using the one or more processors, the one or more parameters of the machine-learning model to generate output text data relating to at least an audio source represented in the input spatial audio.

20. The method of claim 19, wherein the output text data identifies one or more of a distance to the audio source represented in the input spatial audio, a number of audio sources represented in the input spatial audio, or a transcription of speech from a moving audio source represented in the input spatial audio.
